(19) United States
(12) Patent Application Publication
(10) Pub. No.: US 2025/0209778 A1
(43) Pub. Date: Jun. 26, 2025

(54) SYSTEM AND METHOD FOR DYNAMICALLY CAPTURING 3D REGION OF INTEREST

(71) Applicant: eBots Inc., Fremont, CA (US)

(72) Inventor: Jingjing Li, Milpitas, CA (US)

(73) Assignee: eBots Inc., Fremont, CA (US)

(21) Appl. No.: 18/985,724

(22) Filed: Dec. 18, 2024

Related U.S. Application Data
(60) Provisional application No. 63/612,897, filed on Dec. 20, 2023.

(51) Int. Cl. G06V 10/25; G06T 7/11; G06T 7/521; H04N 23/667

(52) U.S. Cl. CPC G06V 10/25; G06T 7/11; G06T 7/521; H04N 23/667

(57) ABSTRACT

One embodiment can provide a method and system for reducing latency in capturing three-dimensional (3D) images. During operation, the system may configure a camera to capture a two-dimensional (2D) image of a scene and perform a machine learning-based object-detection operation on the 2D image to generate a number of bounding boxes, with a respective bounding box corresponding to an object in the scene. The system may further configure the camera to operate in a region of interest (ROI) mode and setting one or more ROI areas based on the generated bounding boxes and configure the camera to capture one or more 3D images of the scene while operating in the ROI mode.

### RELATED APPLICATIONS

This claims the benefit of U.S. Provisional Patent Application No. 63/612,897, Attorney Docket No. EBOT23-1001PSP, entitled “METHOD AND SYSTEM FOR DYNAMICALLY CAPTURING 3-DIMENSIONAL REGION OF INTEREST,” by inventor Jingjing Li, filed 20 Dec. 2023, the disclosure of which is incorporated herein by reference in its entirety for all purposes.

### BACKGROUND

### Field

This disclosure is generally related to three-dimensional (3D) imaging techniques. Particularly, this disclosure is related to a system and method for dynamically detecting 3D region of interest (ROI) for image capturing.

### Related Art

Advanced robotic technologies have ushered in the fourth industrial revolution, known as Industry 4.0, fundamentally transforming manufacturing processes. This revolution built upon the computing and automation advancements of the third industrial revolution, enabling computers and robotics to communicate and make autonomous decisions without human intervention. Industry 4.0 and the concept of smart factories are realized through the convergence of cyber-physical systems, the Internet of Things (IoT), and the Internet of Systems (IoS). In this paradigm, smart machines, including robots, continuously enhance their capabilities by accessing more data and acquiring new skills. This leads to increased efficiency, productivity, and reduced waste in manufacturing environments. The ultimate vision of Industry 4.0 is a network of digitally connected smart machines capable of creating and sharing information. This interconnected ecosystem paves the way for “lights-out manufacturing,” a concept where production can occur without direct human supervision. As these technologies continue to evolve, they promise to revolutionize industrial processes, bringing unprecedented levels of automation and intelligence to the manufacturing sector.

Three-dimensional (3D) computer vision technology has become a cornerstone of modern robotics, revolutionizing manufacturing processes in the electrical and electronic industries. This advanced technology enables the deployment of robots on assembly lines, effectively replacing human workers in many intricate tasks. Assembling electronic devices (especially consumer electronics like smartphones, digital cameras, tablet or laptop computers, etc.) may require hundreds of delicate tasks, such as placement of a component, insertion of a connector, routing of a cable, etc. Such tasks are often performed in a cluttered environment, where the workspace may include many components. 3D computer-vision systems provide robots with the ability to perceive and interpret their surroundings with unprecedented accuracy. This capability allows them to navigate complex spaces and manipulate objects with high precision, even in crowded environments.

Structured light imaging has been widely used to provide accurate 3D depth information with high precision and low latency. The term “structured light” refers to the active illumination of a scene with specially designed, spatially varying intensity patterns. An image sensor (e.g., a camera) acquires 2D images of the scene under structured light illumination. A non-planar surface of the scene distorts the projected structured light pattern, and the 3D surface shape may be extracted based on information about the distortion of the projected structured light pattern. The principle behind structured light imaging is triangulation. By knowing the geometry of the projected light pattern and the position of the camera relative to the projector, the system can determine the precise location of each point on the surface of objects. This process often involves capturing multiple frames from various angles to ensure comprehensive coverage of the object. The overhead of capturing multiple frames makes structured light capturing much more time-consuming than traditional 2D image capturing.

### SUMMARY

One embodiment can provide a method and system for reducing latency in capturing three-dimensional (3D) images. During operation, the system may configure a camera to capture a two-dimensional (2D) image of a scene and perform a machine learning-based object-detection operation on the 2D image to generate a number of bounding boxes, with a respective bounding box corresponding to an object in the scene. The system may further configure the camera to operate in a region of interest (ROI) mode, set one or more ROI areas based on the generated bounding boxes, and configure the camera to capture one or more 3D images of the scene while operating in the ROI mode.

In a variation on this embodiment, the system may perform a machine learning-based image-segmentation operation on the 2D image to determine types of objects in the scene.

In a further variation, setting the one or more ROI areas may include determining whether a bounding box is an ROI area based on an object type corresponding to the bounding box.

In a variation on this embodiment, configuring the camera to capture one or more 3D images may include turning on a structured light projector and configuring the camera to capture images of the scene under illumination of the structured light projector.

In a variation on this embodiment, performing the machine learning-based object-detection operation may include applying a You Only Look Once (YOLO) algorithm.

In a variation on this embodiment, setting the one or more ROI areas may include sending to the camera, via a Serial Peripheral Interface (SPI) interface, position and size of each ROI area.

In a variation on this embodiment, the system may configure the camera to generate an invalid frame before capturing the 3D images.

In a further variation, the system may perform the machine learning-based object-detection operation while the camera is generating the invalid frame.

One embodiment can provide a computer-vision system. The computer-vision system may include a camera to capture a two-dimensional (2D) image of a scene, a camera-control unit, and a machine learning-based object-detection unit to perform an object-detection operation on the 2D image to generate a number of bounding boxes, wherein a respective bounding box corresponds to an object in the scene. The camera-control unit may configure the camera to operate in a region of interest (ROI) mode, set one or more ROI areas based on the generated bounding boxes, and configure the camera to capture one or more 3D images of the scene while operating in the ROI mode.

One embodiment can provide a non-transitory computer-readable storage medium storing instructions that when executed by a computer cause the computer to perform a method for reducing latency in capturing three-dimensional (3D) images. The method can include configuring a camera to capture a two-dimensional (2D) image of a scene and performing a machine learning-based object-detection operation on the 2D image to generate a number of bounding boxes, with a respective bounding box corresponding to an object in the scene. The method may further include configuring the camera to operate in a region of interest (ROI) mode, setting one or more ROI areas based on the generated bounding boxes, and configuring the camera to capture one or more 3D images of the scene while operating in the ROI mode.

### BRIEF DESCRIPTION OF THE FIGURES

FIG. 1 illustrates the exemplary block diagram of a computer-vision system with dynamic ROI settings, according to one embodiment of the instant application.

FIG. 2A illustrates an image frame with non-overlapped cropping, according to one embodiment of the instant application.

FIG. 2B illustrates an image frame with overlapped cropping, according to one embodiment of the instant application.

FIG. 3 presents a flowchart illustrating an exemplary operation process of a computer-vision system, according to one embodiment of the instant application.

FIG. 4 shows a block diagram of an exemplary robotic system, according to one embodiment of the instant application.

FIG. 5 illustrates an exemplary computer system that facilitates the operation of the computer-vision system, according to one embodiment of the instant application.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

Embodiments described herein solve the technical problem of reducing the latency in 3D imaging by reducing the image size. To do so, the 3D computer-vision system may automatically and dynamically determine one or more region of interest (ROI) areas in a scene and configure the image sensor to send out image information (e.g., pixel values) in the determined ROI areas. More specifically, the computer-vision system may first capture a single 2D image of the scene and perform an object-detection operation to generate bounding boxes that are candidates for the ROI areas. Once the ROI areas are determined, the computer-vision system may capture 3D images of the scene, and image data within the determined ROI areas will be sent out for post-processing (e.g., for determining poses of components within the scene).

### Dynamic ROI for 3D Computer-Vision

For robots manipulating small components (e.g., a robotic arm that assembles consumer electronic devices), it may be possible to reduce the latency by reducing the image size, because images of the small components may only occupy a small portion of an image of the workspace. Some image sensors may operate in an ROI mode, where image signals (e.g., pixel values) may be cropped and read out in a number of arbitrary positions. The size of a cropped image is much smaller than the original image, thus reducing the amount of data to be transferred for further processing.

Exiting 3D cameras with ROI-enabled sensors often rely on manual selection of the ROI areas before capturing an image. If the to-be-captured objects and their locations are constantly changing, such as in the fields of augmented reality, virtual reality, robotics, and automation, the manual selection of the ROI areas becomes too slow to meet the imaging needs. Dynamic ROI selection is needed to achieve real-time performance.

In some embodiments of the present disclosure, a 3D computer-vision system may dynamically determine the ROI in a scene based on a single 2D image of the scene. The system may apply a machine learning-based object-detection technique to determine the ROI. More specifically, bounding boxes resulting from the object-detection operation may be used by the system to determine the ROI. In one embodiment, a subset of the bounding boxes may be selected as ROI areas within the scene.

In some embodiments, while performing the object-detection operation, the system may concurrently perform a machine learning-based segmentation operation to identify objects of interest. For example, the object-detection operation may detect a large number of components in a workspace, but only a few components may be involved in the next robotic operation and require their images captured in a subsequent 3D imaging process. The image segmentation outcome allows the system to identify those components needing to be captured and select the corresponding bounding boxes as the ROI areas on the image sensor.

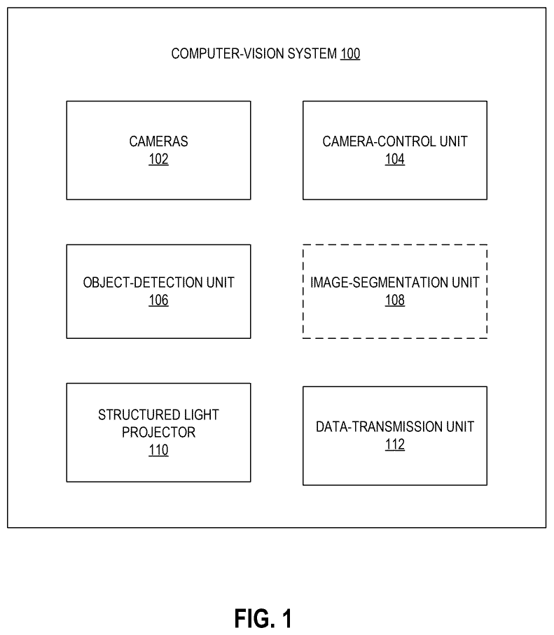

FIG. 1 illustrates the exemplary block diagram of a computer-vision system with dynamic ROI settings, according to one embodiment of the instant application. In FIG. 1, a computer-vision system 100 can include one or more cameras 102, a camera-control unit 104, an object-detection unit 106, an optional image-segmentation unit 108, a structured light projector 110, and a data-transmission unit 112.

Cameras 102 can include one or more image sensors. In some embodiments, cameras 102 may include charge-coupled device (CCD) image sensors and/or complementary metal-oxide-semiconductor (CMOS) image sensors. An image sensor may include a Scalable Low-Voltage Signaling with Embedded Clock (SLVS-EC) interface that facilitates high-speed transfer of image data to an external image processor. The SLVS-EC interface may provide multiple lanes for transferring image data, and each lane may support a maximum data rate of 10 Gbps.

Image sensor within cameras 102 may operate in ROI mode, in which signals of an image frame may be cut out (i.e., cropped) and read out in a number of arbitrary positions. In some embodiments, a sensor may output signals from up to eight cropped areas. The horizontal and vertical positions and widths of the cropped areas can be set using register settings before each image capture.

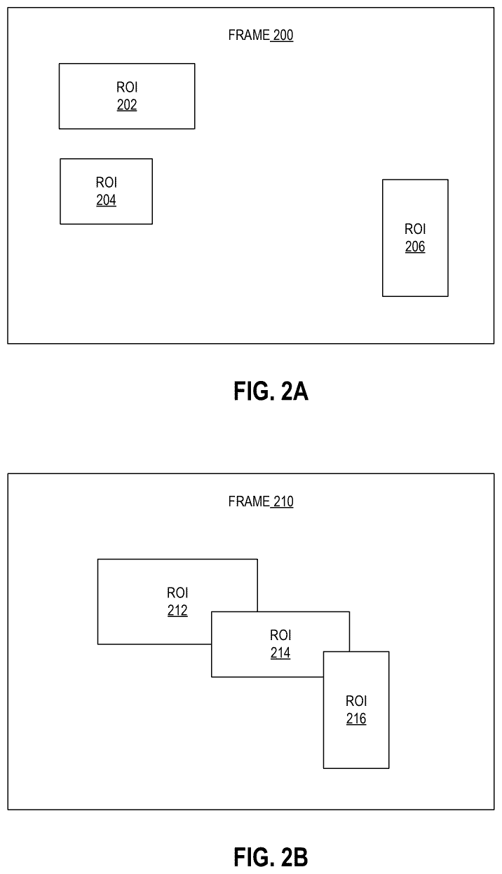

FIG. 2A illustrates an image frame with non-overlapped cropping, according to one embodiment of the instant application. In FIG. 2A, a frame 200 can include a number (e.g., up to eight) of cropped areas that do not overlap with each other, such as cropped areas 202, 204, and 206. The position (i.e., the starting point of the scan or the upper left corner) and width/height of each cropped area may be set by the camera control unit (e.g., by setting the registers associated with the image sensors). In one example, the minimum horizontal width of the combination of the non-overlapped areas is eight pixels, and the minimum vertical width is eight lines.

FIG. 2B illustrates an image frame with overlapped cropping, according to one embodiment of the instant application. In FIG. 2B, a frame 210 can include a number (e.g., up to eight) of cropped areas (e.g., cropped areas 212, 214, and 216), with at least two areas overlapping with each other. The setting of the positions and widths/heights of these overlapped areas can be similar to the setting of the non-overlapped areas. In one example, the minimum horizontal width of each cropped area in the overlapped ROI mode is eight pixels, and the minimum vertical width of each cropped area is eight lines.

When operating in the ROI mode, the frame rate of an image sensor may be

$$Frame rate = \frac{1}{( number lines per frame \times line period )} ,$$

where the number of lines per frame is greater than the minimum vertical width for both the non-overlapped and overlapped ROI modes, and the line period is the time it takes to scan one line. Hence, the fewer the lines per frame, the faster the frame rate. Using 12-bit images as an example, when the image sensor is operating in the non-overlapped ROI node, if the cropped image has 600 vertical lines, the highest frame rate can be 531.20 frames/s; and if the cropped image has only eight vertical lines, the highest frame rate can be 4462.13 frames/s. These frame rates are 1.3 and 18.3, respectively, times faster than the standard frame rate (e.g., 231 frames/s) of an image sensor operating in the all-pixel scan mode. The faster frame rate can lead to improved camera performance.

Returning to FIG. 1, camera-control unit 104 can be responsible for controlling the operation of cameras 102. In some embodiments, camera-control unit 104 may interface with cameras 102 via a Serial Peripheral Interface (SPI) interface. More specifically, it may send control signals via the SPI interface to configure a camera to capture a single 2D frame or multiple 3D frames. In addition, when configuring the cameras to capture the 2D frame, camera-control unit 104 may configure the camera to operate in the all-pixel scan mode. On the other hand, when configuring the camera to capture 3D frames, camera-control unit 104 can set the operation mode of the image sensors in the camera to ROI mode. Moreover, camera-control unit 104 can set the position and width/height of each cropped area within an image frame. In one example, camera-control unit 104 may set the registers associated with the image sensors of camera 102 to configure the image sensors to operate in the ROI mode and to specify the positions and widths/heights of the cropped areas in the captured image frames. In some embodiments, each time after camera-control unit 104 changes the ROI setting of the image sensors (e.g., changes the operation mode from the all-pixel scan mode to the ROI mode or changes the position and/or width/height of a cropped area changes), the image sensors need to generate an invalid frame.

Object-detection unit 106 may be responsible for performing a machine learning-based object-detection operation based on a single 2D image captured by cameras 102. In some embodiments, object-detection unit 106 may implement a deep learning neural network for object detection to output a plurality of bounding boxes. These bounding boxes may be the candidates for the cropped areas. In some embodiments, object-detection unit 106 may send the position and size information of the bounding boxes to camera-control unit 104 such that it can set the positions and widths/heights of the cropped areas in the image sensors. Such cropped areas may also be referred to as ROI areas.

In one embodiment, object-detection unit 106 may implement a You Only Look Once (YOLO) algorithm, such as the YOLOv7 model, to perform real-time object detection. Other versions of the YOLO algorithm (e.g., YOLOv8 and YOLOv9) are also possible. The family of the YOLO models can use a single feed-forward fully convolutional network to provide the bounding boxes and object classification. Object-detection unit 106 may also implement other one-stage models, such as RetinaNet and FCOS (Fully Convolutional One-Stage Object Detection). Compared with two-stage object-detection frameworks (e.g., Faster R-CNN and MobileNet) that divide the object detection into a region-proposal stage and an object classification stage, the one-stage object-detection schemes are much faster in inference because they do not need the proposal generation step.

Image-segmentation unit 108 may be responsible for performing image segmentation to identify the types of the detected components. For example, image-segmentation unit 108 can implement an instance-segmentation neural network that can output a mask for each detected object in the scene. Image-segmentation unit 108 may also determine the type of each detected component (e.g., based on a component library). The field of view (FOV) of cameras 102 may include the end effector of the robotic arm and many (e.g., tens of) components, and not all components are relevant to the current operation of the robot. For example, if the pending job of the robotic arm is to pick up an RF connector to insert it into a socket, then the relevant components in the scene may include the end effector, the connector, and the socket. To guide the movement of the robotic arm, computer-vision system 100 only needs to capture images of the relevant components and ignore other components in the scene. By determining the type of each detected component (e.g., end effector, RF connector, socket, etc.), the system may select a subset of bounding boxes output by object-detection unit 106 as the ROI areas. In one example, image-segmentation unit 108 may send the segmentation result to camera-control unit 104, which may then select a subset of relevant bounding boxes based on the segmentation result. Image-segmentation unit 108 may be optional, as it is also possible to treat all bounding boxes as ROI areas.

Structured light projector 110 can be responsible for projecting structured light onto the to-be-captured scene. In some embodiments, structured light projector 110 can include a Digital Light Processing (DLP) projector that can project codified images (e.g., spatially varying light patterns) onto the scene. The DLP projector can use a laser diode (LD) as a light source and use a digital micromirror device (DMD) to codify the projecting patterns. A more detailed description of a laser-based structured light projector can be found in U.S. patent application Ser. No. 18/016,269 (Attorney Docket No. EBOT19-1001US_371), entitled “SYSTEM AND METHOD FOR 3D POSE MEASUREMENT WITH HIGH PRECISION AND REAL-TIME OBJECT TRACKING,” by inventors MingDu Kang, Kai C. Yung, Wing Tsui, and Zheng Xu, filed 13 Jan. 2023, the disclosure of which is incorporated herein by reference. In some embodiments, structured light projector 110 may be turned on (e.g., by camera-control unit 104) to facilitate cameras 102 in capturing 3D images of the scene. In one example, structured light projector 110 may have a frame rate of 2500 fps, meaning that the image capturing latency depends mostly on the frame rate of cameras 102.

Data-transmission unit 112 can be responsible for transmitting the image data from computer-vision system 100 to an image processor, which can then determine the pose of the end effector and a component to be picked up by the end effector (e.g., a connector). A robotic controller may then control the movement of the robotic arm based on the determined pose.

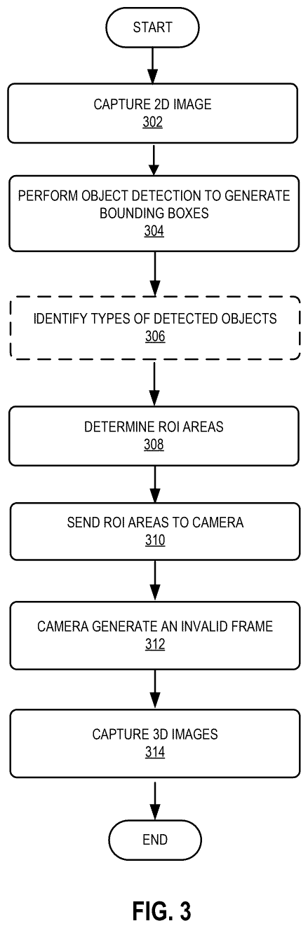

FIG. 3 presents a flowchart illustrating an exemplary operation process of a computer-vision system, according to one embodiment of the instant application. Although the exemplary operation process in FIG. 3 shows a specific order of performing certain operations, the scope of this disclosure is not limited to such order. For example, the operations shown in succession in the flowchart may be performed in a different order, may be executed concurrently, or with partial concurrence or combinations thereof.

During operation, the computer-vision system may configure the camera to capture a 2D image of the workspace of a robotic arm (operation 302). In one example, the robotic arm may perform a task for assembling an electronic device, and the workspace can include the robotic arm and a number of to-be-assembled components. The computer-vision system may capture the 2D image of the workspace after the robotic arm moves to a new location to perform a new operation. Note that the robotic arm may move according to a predetermined path, but such movement typically cannot meet the precision requirement of the assembly task of consumer electronics, which may require a precision of sub-millimeters. Therefore, each time after the movement of the robotic arm, the computer-vision system needs to capture images of the scene to determine the exact pose of the end effector and the to-be-assembled components.

The computer-vision system can perform object detection to generate a number of bounding boxes in the 2D image (operation 304). In some embodiments, the computer-vision system may implement a deep-learning neural network (e.g., a YOLOv7 model) to detect objects in the 2D image. The computer-vision system can optionally identify the types of detected objects (e.g., end effector, RF connectors, other types of electronic components, etc.) (operation 306). In some embodiments, instead of performing the object-detection operation, the computer-vision system may implement a deep-learning neural network to segment the 2D image to generate bounding boxes as well as determining the shape of each detected object. In one embodiment, the computer-vision system may rely on a component library, which stores shape and size information associated with various components, to determine the component type of a detected object.

Subsequently, the computer-vision system may determine a number of ROI areas (operation 308). In some embodiments, the system may determine the ROI areas as all of the bounding boxes resulted from the object-detection operation (i.e., operation 306). In alternative embodiments, the system may determine the ROI areas as a subset of the bounding boxes based on the result of the image-segmentation operation (i.e., operation 308). More specifically, the system may determine whether a particular bounding box is an ROI area based on the component type corresponding to that particular bounding box. For example, if the component type of a bounding box is the end effector, then the system can determine that the bounding box is an ROI area.

Subsequent to determining the ROI areas, the system may send the determined ROI areas to the camera (operation 310). For example, the system may set the operation mode of the image sensors within the camera to ROI mode and set the positions and sizes of the ROI areas by setting a number of registers associated with the image sensors. In response to receiving the update to the ROI setting, the camera may generate an invalid frame (operation 312). The camera may then capture 3D images of the workspace (operation 314). Note that the FOV of the camera remains unchanged between the 2D and 3D image captures, such that objects within the bounding boxes of the 2D image will also be captured in the 3D image.

To capture the 3D images, the computer-vision system may turn on the structured light projector and configure the camera to capture images of the workspace under the illumination of the structured light projector. When the camera is operating in the ROI mode, for each captured frame, the image sensor only outputs image signals within the ROI areas. More specifically, only the pixel values within the ROI areas are read out, thus increasing the frame rate and reducing latency. Depth information associated with the ROI areas in the captured scene may be extracted from the 3D images, thus allowing the computer-vision system to accurately determine the pose of the end effector and components to be operated on. The robotic controller may then use the accurate pose information to control the movement of the robotic arm and end effector to perform the desired assembling task.

In the example shown in FIG. 3, responsive to receiving the update to the ROI settings, the camera generates an invalid frame. In some examples, to further improve efficiency, the camera may preemptively generate an invalid frame before receiving the updated ROI settings. More specifically, the camera may generate an invalid frame when the computer-vision system is performing other tasks, such as the object-detection task and/or the image-segmentation task.

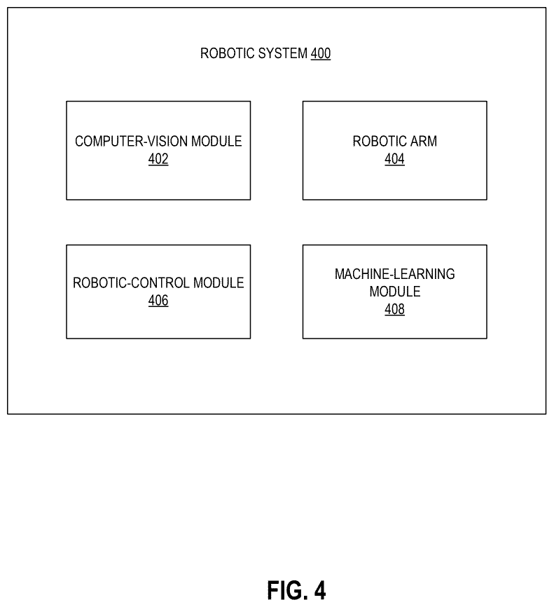

FIG. 4 shows a block diagram of an exemplary robotic system, according to one embodiment of the instant application. Robotic system 400 can include a computer-vision module 402, a robotic arm 404, a robotic-control module 406, and a machine learning module 408. Robotic system 400 may have more or fewer components than those shown in FIG. 4.

Computer-vision module 402 can include one or more cameras and a structured light projector. The cameras may be configured to capture 2D and 3D images of the work scene. More specifically, when capturing the 3D images, the cameras may be configured to operate in ROI mode to reduce the image size and increase efficiency. When assembling consumer electronics, components involved in each operation may be small and may fit within eight vertical lines (i.e., the smallest possible cropped area). The overall image capturing latency (including the 2D image capturing, the object detection, and the 3D image capturing) for such small objects in the ROI mode may be less than 20 ms, which is much smaller than the latency of the all-pixel scan mode, which is around 95 ms. Moreover, the smaller image size may expedite the processing speed of the 3D images.

Robotic arm 404 can have multiple joints and six degrees of freedom (6DoF). The end-effector of robotic arm 404 can move freely in the FOV of the cameras of computer-vision module 402. In some embodiments, robotic arm 604 can include multiple sections, with adjacent sections coupled to each other via a rotational joint. Each rotational joint can include a servo motor capable of continuous rotation within a particular plane. The combination of the multiple rotational joints can enable robotic arm 404 to have an extensive range of movement with 6DoF.

Robotic-control module 406 can be responsible for controlling the movement of robotic arm 404. Robotic-control module 406 can generate a motion plan, which can include a sequence of motion commands that can be sent to each individual motor in robotic arm 404 to facilitate movements of its end effector to accomplish particular assembling tasks, such as picking up a component, moving the component to a desired mounting location, and mounting the component. Due to errors included in the system (e.g., encoder errors at each motor), when robotic-control module 406 instructs the robotic arm to move the end effector to one pose, the end effector may end up in a slightly different pose.

To accomplish the desired task, after each movement of the robotic arm, computer-vision module 402 needs to determine the current pose of the end effector (e.g., by capturing and analyzing 3D images of the work scene). The smaller size of the 3D images captured in the ROI mode may expedite the post-processing of the 3D images.

Machine-learning module 408 may implement deep-learning neural networks (e.g., YOLO models) to perform object detection and/or image segmentation. More specifically, bounding boxes generated by the object-detection or image-segmentation neural network may be used as ROI areas (e.g., a plurality of bounding boxes) by the cameras in computer-vision module 402 for capturing 3D images. When performing the image-segmentation task, machine-learning module 408 may rely on a component library that stores information associated with the various components involved in the assembling task. Machine-learning module 408 may send the results of object detection and/or image segmentation to computer-vision module 402 to facilitate the determination of ROI areas in the image sensor before the 3D images are captured.

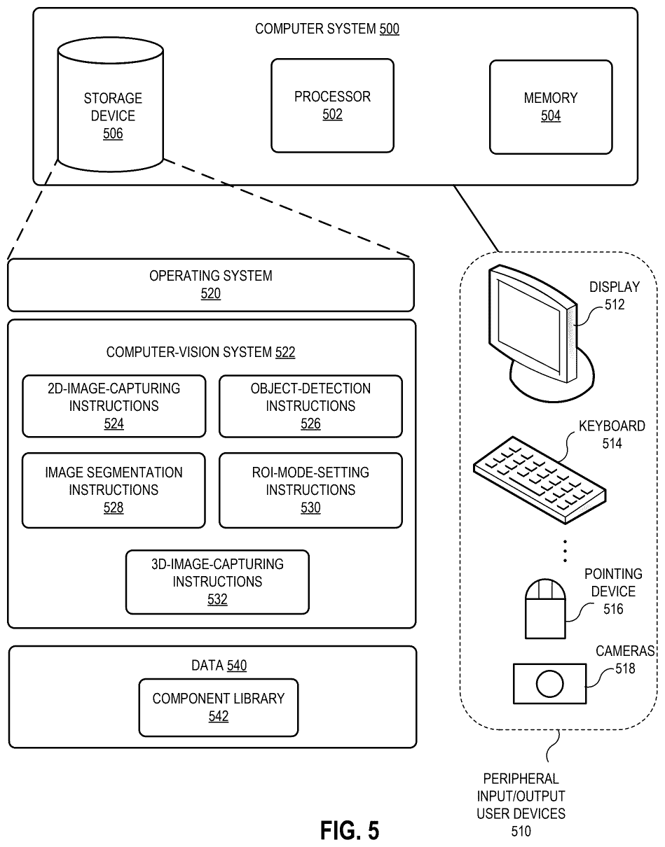

FIG. 5 illustrates an exemplary computer system that facilitates the operation of the computer-vision system, according to one embodiment of the instant application. Computer system 500 includes a processor 502, a memory 504, and a storage device 506. Furthermore, computer system 500 can be coupled to peripheral input/output (I/O) user devices 510, e.g., a display device 512, a keyboard 514, a pointing device 516, and cameras 518. Storage device 506 can be a computer-readable storage medium that stores an operating system 520, a computer-vision system 522, and data 540.

Computer-vision system 522 can include instructions, which when executed by computer system 500, can cause computer system 500 or processor 502 to perform methods and/or processes described in this disclosure. Specifically, computer-vision system 522 can include instructions for capturing a 2D image of the current work scene (2D-image-capturing instructions 524), instructions for performing a machine learning-based object-detection task (object-detection instructions 526), instructions for performing a machine learning-based image-segmentation task (image-segmentation instructions 528), instructions for setting the ROI mode of the cameras (ROI-mode-setting instructions 530), and instructions for capturing 3D images in the ROI mode (3D-image-capturing instructions 532). Data 540 can include a component library 542.

As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processor may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution.

As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

In general, embodiments of the present invention can provide a system and method for reducing the latency for capturing 3D images and transmitting the image data. Before capturing images under the illumination of a structured light projector (i.e., before capturing 3D images), a computer-vision system may be configured to capture a single 2D image of the scene. The single 2D image may be analyzed (e.g., using a machine learning-based object detection technique) to generate a number of bounding boxes, with each bounding box corresponding to a detected object (e.g., the end effector of a robotic arm or a component to be picked up by the end effector). The computer-vision system may further configure the camera to operate in ROI mode. The computer system may dynamically update the ROI settings based on the bounding boxes. In one example, analyzing the 2D image may include performing a machine learning-based image segmentation to identify the type of each detected component. The system may select a subset of bounding boxes corresponding to components of interest (i.e., components involved in the pending robotic operation) as ROI areas. The computer system may then capture the 3D images of the scene under the dynamically updated ROI settings.

In addition to reduce the latency in capturing 3D images, the determination of the ROI settings may also expedite 2D image capturing. For example, the ROI settings of a camera may be determined based on the bounding boxes in a low-resolution 2D image, and the camera may then capture a number of high-resolution 2D images using the determined ROI settings. The size of the captured images is much smaller compared with non-ROI images, thus leading to reduced latency in image capturing and transferring.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware devices or apparatus. The hardware modules or apparatus can include, but are not limited to, application-specific integrated circuit (ASIC) chips, field-programmable gate arrays (FPGAs), dedicated or shared processors that execute a particular software unit or a piece of code at a particular time, and other programmable-logic devices now known or later developed. When the hardware devices or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for reducing latency in capturing three-dimensional (3D) images, the method comprising:
configuring, by a computer, a camera to capture a two-dimensional (2D) image of a scene;
performing a machine learning-based object-detection operation on the 2D image to generate a number of bounding boxes, wherein a respective bounding box corresponds to an object in the scene;
configuring the camera to operate in a region of interest (ROI) mode;
setting one or more ROI areas based on the generated bounding boxes; and
configuring the camera to capture one or more 3D images of the scene while operating in the ROI mode.

2. The computer-implemented method of claim 1, further comprising performing a machine learning-based image-segmentation operation on the 2D image to determine types of objects in the scene.

3. The computer-implemented method of claim 2, wherein setting the one or more ROI areas comprises determining whether a bounding box is an ROI area based on an object type corresponding to the bounding box.

4. The computer-implemented method of claim 1, wherein configuring the camera to capture one or more 3D images comprises turning on a structured light projector and configuring the camera to capture images of the scene under illumination of the structured light projector.

5. The computer-implemented method of claim 1, wherein performing the machine learning-based object-detection operation comprises applying a You Only Look Once (YOLO) algorithm.

6. The computer-implemented method of claim 1, wherein setting the one or more ROI areas comprises sending to the camera, via a Serial Peripheral Interface (SPI) interface, position and size of each ROI area.

7. The computer-implemented method of claim 1, further comprising configuring the camera to generate an invalid frame before capturing the 3D images.

8. The computer-implemented method of claim 7, further comprising performing the machine learning-based object-detection operation while the camera is generating the invalid frame.

9. A computer-vision system, comprising:
a camera to capture a two-dimensional (2D) image of a scene;
a camera-control unit; and
a machine learning-based object-detection unit to perform an object-detection operation on the 2D image to generate a number of bounding boxes, wherein a respective bounding box corresponds to an object in the scene;
wherein the camera-control unit is to:
configure the camera to operate in a region of interest (ROI) mode;
set one or more ROI areas based on the generated bounding boxes; and
configure the camera to capture one or more 3D images of the scene while operating in the ROI mode.

10. The computer-vision system of claim 9, further comprising a machine learning-based image-segmentation unit to perform an image-segmentation operation on the 2D image to determine types of objects in the scene.

11. The computer-vision system of claim 10, wherein, while setting the ROI areas, the camera-control unit is to determine whether a bounding box is an ROI area based on an object type corresponding to the bounding box.

12. The computer-vision system of claim 9, wherein, while configuring the camera to capture one or more 3D images, the camera-control unit is to turn on a structured light projector and configure the camera to capture images of the scene under illumination of the structured light projector.

13. The computer-vision system of claim 9, wherein, while performing the machine learning-based object-detection operation, the machine learning-based object-detection unit is to apply a You Only Look Once (YOLO) algorithm.

14. The computer-vision system of claim 9,
wherein the camera-control unit comprises a Serial Peripheral Interface (SPI) interface; and
wherein, while setting the one or more ROI areas, the camera-control unit is to send the position and size of each ROI area to the camera via the SPI interface.

15. The computer-vision system of claim 9, wherein the camera-control unit is to configure the camera to generate an invalid frame while the machine learning-based object-detection unit is performing the object-detection operation.

16. A non-transitory computer-readable storage medium storing instructions that when executed by a computer cause the computer to perform a method for reducing latency in capturing three-dimensional (3D) images, the method comprising:
configuring a camera to capture a two-dimensional (2D) image of a scene;
performing a machine learning-based object-detection operation on the 2D image to generate a number of bounding boxes, wherein a respective bounding box corresponds to an object in the scene;
configuring the camera to operate in a region of interest (ROI) mode;
setting one or more ROI areas based on the generated bounding boxes; and
configuring the camera to capture one or more 3D images of the scene while operating in the ROI mode.

17. The non-transitory computer-readable storage medium of claim 16, wherein the method further comprises performing a machine learning-based image-segmentation operation on the 2D image to determine types of objects in the scene, and wherein setting the one or more ROI areas comprises determining whether a bounding box is an ROI area based on an object type corresponding to the bounding box.

18. The non-transitory computer-readable storage medium of claim 16, wherein configuring the camera to capture one or more 3D images comprises turning on a structured light projector and configuring the camera to capture images of the scene under illumination of the structured light projector.

19. The non-transitory computer-readable storage medium of claim 16, wherein setting the one or more ROI areas comprises sending to the camera, via a Serial Peripheral Interface (SPI) interface, position and size of each ROI area.

20. The non-transitory computer-readable storage medium of claim 16, wherein the method further comprises, while performing the object-detection operation, configuring the camera to generate an invalid frame.
